(19) United States
(12) Patent Application Publication
(10) Pub. No.: US 2024/0378027 A1
(43) Pub. Date: Nov. 14, 2024

(54) SELF-CHECKING RANDOM ASSEMBLY GENERATOR FOR RISC-V PROCESSOR

(71) Applicant: MediaTek Singapore Pte. Ltd., Singapore (SG)

(72) Inventors: Rishna Patteri, Bengaluru KA (IN); Srinivasa Sudhakar Tipparaju, Bengaluru KA (IN); Sahil Bhadwal, Bengaluru KA (IN); Bijay Kumar Sharma, Bengaluru KA (IN); Karun Kumar Talari, Bengaluru KA (IN)

(73) Assignee: MediaTek Singapore Pte. Ltd., Singapore (SG)

(21) Appl. No.: 18/658,980

(22) Filed: May 8, 2024

(30) Foreign Application Priority Data
May 11, 2023 (IN) 202321033409

(51) Int. Cl. G06F 8/30

(52) U.S. Cl. CPC G06F 8/30

(57) ABSTRACT

A random assembly code generator (RACG) for generating an assembly code for a RISC-V processor includes: a multi-layer structure, wherein each layer has a specific and individual set of constraints defining a set of instructions which can be generated by each layer. The RACG is arranged to generate a random instruction for each layer of the multi-layer structure according to the specific and individual set of constraints, combine the generated random instructions into a random instruction sequence, and convert the random instruction sequence to an assembly code for the RISC-V processor.

### BACKGROUND

This invention is directed to RISC-V processors, and more particularly, to a self-checking random assembly generator which performs a verification process for a RISC-V processor.

Every processor has an Instruction Set Architecture (ISA), which is a blueprint outlining a set of instructions for a processor to execute. RISC-V is an open-source ISA based on the principles of Reduced Instruction Set Computing (RISC). Complex Instruction Set Computing (CISC) architectures have a large set of complex instructions, whereas RISC comprises a smaller set of simple instructions that can be tailored for a specific processor which has certain end applications. RISC architecture enables a processor to be built and customized according to these end applications, wherein the ISA can pick and choose from available features to develop a small core set of instructions, rather than using the entire feature set. In this way, RISC enables more efficient use of hardware as well as faster execution of instructions.

Usually, a program to be executed by a computer is written as source code, e.g. in C or C++, and then converted (compiled) into object code which can be directly executed by a CPU. The object code consists of successive instructions in machine language, and will be stored in a memory at the computer, which can then execute the program. A RISC type of CPU can execute instructions from among a small set of object code instructions. These perform respective simple functions and can have short execution times.

Even within this small core set of instructions, however, functionality of the processor needs to be verified. A standard technique for performing verification is to use a random instruction stream generator, which generates a set of instructions in a sequence or combination to test the full range and expected operation of a RISC-V processor. The randomness of the instructions is important to test the design in unique ways to cover extreme corner cases. If, however, the random, instruction stream generator generates unnecessary sequences/combinations, the efficiency of the testing process will be reduced. In order to provide some level of control over the verification process, the Google open source project, RISC-V ISG, has been developed to produce a constrained set of tests, wherein random instructions chains are generated to exercise core features of the RISC-V processor.

Within these constrained set of tests, the generated sequences must be checked with known values to determine the processor is functioning correctly. The generated instructions are executed by the core through RTL simulation and also by a reference RISC-V instruction set simulator (ISS). Core states of both are compared after each executed instruction and an error is reported in case of a mismatch.

As the generated sequences must undergo self-checking/post processing to find errors, this will slow down the verification process. Moreover, an early failure may invalidate all the subsequent events. It is also possible that a number of test cases are generated which do not match any real-world scenarios required by the processor. If the amount of generated instructions/sequences is reduced, however, the verification process may not cover all corner cases which the processor may be expected to handle, and this may result in errors when operating the RISC-V processor.

### SUMMARY

It is therefore an objective of the present invention to provide a self-checking process for an RISC-V processor which can speed up the entire process, while still ensuring the randomness of generated instructions to cover extreme corner cases.

With this in mind, the present invention provides a random assembly code generator (RACG) for generating an assembly code for a RISC-V processor. The RACG comprises: a multi-layer structure, wherein each layer has a specific and individual set of constraints defining a set of instructions which can be generated by each layer. The RACG is arranged to generate a random instruction for each layer of the multi-layer structure according to the specific and individual set of constraints, combine the generated random instructions into a random instruction sequence, and convert the random instruction sequence to an assembly code for the RISC-V processor.

A verification method for a RISC-V processor is also provided. The verification method can generate assembly codes according to randomly generated test instructions, and comprises: providing a random assembly test code generator (RACG) comprising a multi-layer structure, wherein each layer has a specific and individual set of constraints defining a set of instructions which can be generated by each layer; generating a random instruction for each layer of the multi-layer structure according to the specific and individual set of constraints; combining the generated random instructions into a random instruction sequence; and converting the random instruction sequence to an assembly code for the RISC-V processor.

The RACG is further arranged to set weighted values for each layer, and the random instructions for each layer are further generated according to the set weighted values. The weighting can be predetermined, or dynamically performed. The weighting can be dynamically determined by a user.

The RACG is arranged to set a specific instruction from the set of instructions which can be generated for each layer. The RACG is further arranged to simulate each generated random instruction using a Register Transfer Level (RTL) and compare the result with known values to self-check the random instruction.

A first layer of the multi-layer structure generates random instructions with constrains, a second layer of the multi-layer structure generates mini-expressions, a third layer of the multi-layer structure generates exceptions, a fourth layer of the multi-layer structure generates fragmented boot codes, and a fifth layer of the multi-layer structure generates algorithms. The assembly code is generated using Python programming language.

A feedback method for a RISC-V processor verification process is also provided, the feedback method comprising: for a set number of verification iterations, receiving a generated random instruction sequence from a random assembly code generator (RACG); accessing a database storing all generated random instruction sequences for the set number of verification iterations; determining the current generated random instruction sequence is a repeated sequence if it is already stored in the database; and when the current generated random instruction sequence is a repeated sequence, instructing the RACG to discard the current generated random instruction sequence.

When the current generated random instruction sequence is not a repeated sequence, the method further comprises: updating the number of verification iterations by one; determining if the updated number of verification iterations is equal to the set number of verification iterations; and when the updated number of verification iterations is equal to the set number of verification iterations, outputting a text file containing a disassembled instruction stream according to the database.

When the updated number of verification iterations is not equal to the set number of verification iterations, the method further comprises: updating the database with the current generated random instruction sequence. In one embodiment, the database is a look-up table (LUT).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a random assembly code generator according to an exemplary embodiment of the present invention.

FIG. 2 is a diagram of the random assembly code generator illustrated in FIG. 1 according to another exemplary embodiment of the present invention.

FIG. 3 is a flowchart of a feedback method of the present invention.

### DETAILED DESCRIPTION

The invention is directed to an improvement on the Google Open source verification technique, which generates random instruction sequences for a RISC-V processor. A standard random instruction stream generator can be supplied with various parameters comprising probabilities, a random seed, and other information relating to number of codesets, length of said codesets etc. In addition, the random instruction stream generator will be controlled with a control file containing various parameters and values, which will set the distribution of instructions and the probability of other events. By adjusting settings in the control file, different areas of the test space can be tested, and a user can focus on specific areas which may be at risk. The random instruction stream generator can also be tailored to different types of processor so that specific test cases for the specific concerns of the processor are generated. The aim is to generate a large variety of cases from a particular control file, meaning that some code generators may need specific control parameters. It is not desirable, however, to have too many control parameters, as this will lead to unwieldy control files, and can even remove the randomness of the generated test cases (i.e. corner cases will not be generated due to excess control of the random instruction stream generator).

The aim of the present invention is to provide a random assembly code generator (RACG) which has a layer-based approach for generating random instruction sequences, wherein this layered structure can generate different flavours of randomization which more accurately target real-world scenarios. By combining different random generated instructions, the RACG can generate assembly codes which can more accurately determine the processor's validity. In addition, a feedback mechanism is provided for the assembly codes, such that repeated sequences are not tested.

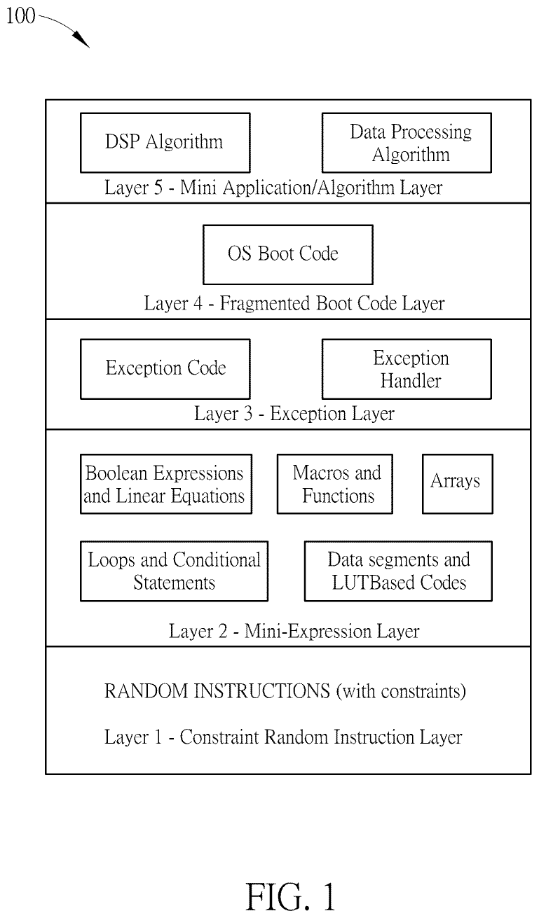

Refer to FIG. 1, which is a diagram of the random assembly code generator (RACG) 100 according to an exemplary embodiment of the present invention. As shown in the diagram, the RACG 100 comprises five layers, which can mimic a CPU operation. Each layer provides a different flavor of randomization such that more realistic scenarios can be generated for a RISC-V processor.

Layer 1 generates random instructions with certain constraints, and operates largely in the same way as the standard Google RISC-V dv. Layer 2 is termed a mini-expression layer, and can generate Boolean expressions and linear equations, macros and functions, arrays, loops and conditional statements, and data segments and look-up table (LUT) based codes. As compared to Layer 1, this is a higher level of randomness.

Layer 3 is termed an exception layer and generates exception codes and exception handlers. Layer 4 is termed a fragmented boot code layer and generates OS boot codes. Finally, Layer 5 is termed a mini application/algorithm layer, and generates DSP algorithms and Data processing algorithms.

Each layer will have a different block of code corresponding to the type of instructions it can generate. The RACG 100 can also provide weighting values for particular layers, wherein more weight may be given to (for example) Layer 2 if the verification procedure is particularly directed to verifying linear equations. The amount of weighting may be predetermined or can be set by a user. Furthermore, the code for each layer may be tailored such that only certain types of instructions will be generated for that particular layer. As an example, the code may be tailored for Layer 2 to instruct that layer to only generate ‘add’ instructions. In this way, the layered RACG 100 can provide a mix and match approach to generating random instruction sequences. As a user will know the particular operations for which a specific RISC-V processor has been designed, the flavours of random generated instructions can be tuned to more closely match the real-world scenarios of the RISC-V processor.

With regards to the weighting values, the method will generate a random weight for an instruction type (wherein said weight may be predetermined or may be set by a user), and then generate randomly determined computer code. A statistical likelihood of generating the instruction type in the code is based on the random weight for the generated instruction type. The RACG 100 will then produce an output file in which the proportion of the one computer instruction type is related to the random weight.

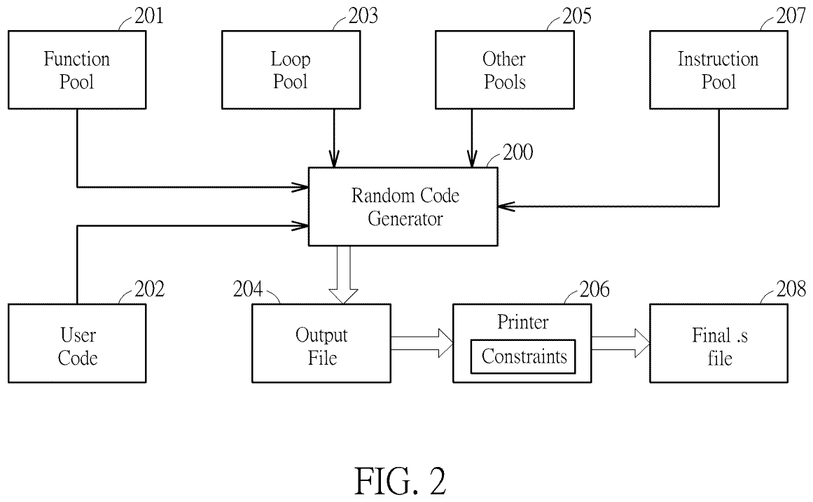

Once each layer has generated random instructions, the RACG 100 can generate an assembly code accordingly. Refer to FIG. 2, which illustrates an internal architecture of the RACG 100. As shown in the diagram, the RACG 100 comprises a central random code generator 200 which receives random instructions from a function pool 201, a loop pool 203, an instruction pool 207, and other pools 205 (which may comprise a bitwise operation pool and an exception pool but are not illustrated in FIG. 2). As well as receiving all the instructions, the random code generator also receives a user code 202. All these inputs are combined to generate an output file 204, which is then input to a printer 206 which can add constraints. The printer then generates an assembly file 208 (final .s file) which is the generated assembly code, and is a text listing of the disassembled instruction stream and their associated memory addresses, and is the output of the execution that occurs after generation has been entirely completed.

The above method and device enable an assembly code to be generated which can cover all unexpected corner cases and scenarios. Verification of a processor may have a limited time: for example, it may apply to 1,000 test cases. The more random and less specific the test cases generated are, the less likely the verification process is able to detect a bug. By tailoring the generated test instructions to match a desired operation performed by a RISC-V processor, each corner of a design can be touched which makes it easier to catch a bug.

The RACG 100 generates a number of test sequences for detecting bugs and determining validity of the RISC-V processor. As detailed above, the entire verification process is limited to a certain number of iterations. If generation of any repeated sequences could be eliminated so that only new sequences are tested, the average time for verification can be improved. The invention therefore provides a feedback method which can detect and discard any repeated sequences. Eliminating the repeated sequences so that only new sequences are tested can help improve coverage in a limited time.

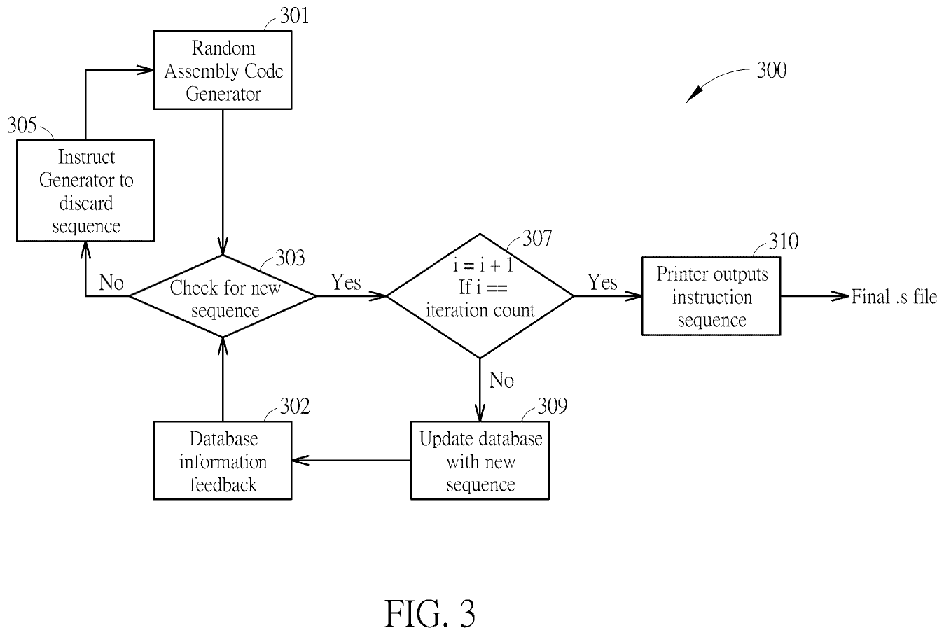

This is achieved by providing a feedback mechanism. Refer to FIG. 3, which is a flowchart of a feedback method for detecting and discarding repeated sequences. As shown in FIG. 3, the method comprises the following steps:
Step 301: Random Assembly Code Generator generates a sequence
Step 302: The database provides information feedback
Step 303: Compare the generated sequence with the database information. Is the sequence new, i.e. is it determined the current generated sequence does not exist in the database? If yes, go to Step 307; if no, go to Step 305
Step 305: Instruct the RACG to discard the current generated sequence
Step 307: Update the iteration count i to be i+1. Does i==the predetermined iteration count? If yes, go to Step 310; if no, go to Step 309
Step 309: Update the database with the current generated sequence
Step 310: The printer outputs the instruction sequence to generate the final .s file

As shown above, the feedback method compares sequences within a database to make sure that no code is repeated, wherein the database may be realized by a look-up table (LUT). This will require some extra storage which increases the overhead slightly; however, the feedback mechanism can help catch bugs faster than the related art such that the overall effect is that the verification process is faster and more efficient than in the related art.

In one exemplary embodiment, the method of the present invention is carried out using Python code. Other programming languages are also possible.

The printer illustrated in FIG. 2 can add further data segments such as headers when generating the output file. Drivers on top of the RISC-V processor are used to convert the instructions into the assembly code.

By providing a multi-layered random instruction stream generator wherein constraints and weights can be set for each layer, the method and device of the present invention enable random instruction sequences and assembly code to be generated for a RISC-V processor which more clearly matches real-world scenarios as well as covering extreme corner cases. By providing weighting values for each layer as well as user code which can select specific instructions within each layer, a mix and match approach is achieved wherein different flavours of randomization are achieved according to particular constraints of each processor. In addition, a feedback method can determine when a generated sequence is repeated and discard any repeated sequences in order to achieve a more efficient verification process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A random assembly code generator (RACG) for generating an assembly code for a RISC-V processor, the RACG comprising:
a multi-layer structure, wherein each layer has a specific and individual set of constraints defining a set of instructions which can be generated by each layer;
and the RACG is arranged to generate a random instruction for each layer of the multi-layer structure according to the specific and individual set of constraints, combine the generated random instructions into a random instruction sequence, and convert the random instruction sequence to an assembly code for the RISC-V processor.

2. The RACG of claim 1, wherein the RACG is further arranged to set weighted values for each layer, and the random instructions for each layer are further generated according to the set weighted values.

3. The RACG of claim 2, wherein the weighting is predetermined.

4. The RACG of claim 2, wherein the weighting is dynamically performed.

5. The RACG of claim 4, wherein the weighting is dynamically determined by a user.

6. The RACG of claim 1, wherein the RACG is arranged to set a specific instruction from the set of instructions which can be generated for each layer.

7. The RACG of claim 1, wherein the RACG is arranged to simulate each generated random instruction using a Register Transfer Level (RTL) and comparing the result to known values to self-check the random instruction.

8. The RACG of claim 1, wherein a first layer of the multi-layer structure generates random instructions with constrains, a second layer of the multi-layer structure generates mini-expressions, a third layer of the multi-layer structure generates exceptions, a fourth layer of the multi-layer structure generates fragmented boot codes, and a fifth layer of the multi-layer structure generates algorithms.

9. The RACG of claim 1, wherein the assembly code is generated using Python programming language.

10. A verification method for a RISC-V processor, which can generate assembly codes according to randomly generated test instructions, the verification method comprising:
providing a random assembly test code generator (RACG) comprising a multi-layer structure, wherein each layer has a specific and individual set of constraints defining a set of instructions which can be generated by each layer;
generating a random instruction for each layer of the multi-layer structure according to the specific and individual set of constraints;
combining the generated random instructions into a random instruction sequence; and
converting the random instruction sequence to an assembly code for the RISC-V processor.

11. The verification method of claim 10, wherein the step of generating a random instruction for each layer of the multi-layer structure according to the specific and individual set of constraints further comprises:
setting weighted values for each layer; and
generating the random instructions for each layer according to the set weighted values.

12. The verification method of claim 11, wherein the weighting is predetermined.

13. The verification method of claim 11, wherein the weighting is dynamically performed.

14. The verification method of claim 13, wherein the weighting is dynamically determined by a user.

15. The verification method of claim 10, wherein the step of providing a random assembly test code generator (RACG) comprising a multi-layer structure comprises:
setting a specific instruction from the set of instructions which can be generated for each layer.

16. The verification method of claim 10, further comprising:
simulating each generated random instruction using a Register Transfer Level (RTL); and
comparing the result to known values to self-check the random instruction.

17. The verification method of claim 10, wherein a first layer of the multi-layer structure generates random instructions with constrains, a second layer of the multi-layer structure generates mini-expressions, a third layer of the multi-layer structure generates exceptions, a fourth layer of the multi-layer structure generates fragmented boot codes, and a fifth layer of the multi-layer structure generates algorithms.

18. The verification method of claim 10, wherein the step of generating the assembly code uses Python programming language.

19. A feedback method for a RISC-V processor verification process, comprising:
for a set number of verification iterations, receiving a generated random instruction sequence from a random assembly code generator (RACG);
accessing a database storing all generated random instruction sequences for the set number of verification iterations;
determining the current generated random instruction sequence is a repeated sequence if it is already stored in the database; and
when the current generated random instruction sequence is a repeated sequence, instructing the RACG to discard the current generated random instruction sequence.

20. The feedback method of claim 19, wherein when the current generated random instruction sequence is not a repeated sequence, the method further comprises:
updating the number of verification iterations by one;
determining if the updated number of verification iterations is equal to the set number of verification iterations; and
when the updated number of verification iterations is equal to the set number of verification iterations, outputting a text file containing a disassembled instruction stream according to the database.

21. The feedback method of claim 20, wherein when the updated number of verification iterations is not equal to the set number of verification iterations, the method further comprises:
updating the database with the current generated random instruction sequence.

22. The feedback method of claim 19 wherein the database is a look-up table (LUT).
